(19) United States
(12) Patent Application Publication
(10) Pub. No.: US 2026/0163493 A1
(43) Pub. Date: Jun. 11, 2026

(54) CURRENT RECTIFIER AND METHOD OF USING A CURRENT RECTIFIER

(71) Applicant: STMicroelectronics International N.V., Geneva (CH)

(72) Inventors: Margaux RENAUD, Antibes (FR); Marc HOUDEBINE, Crolles (FR)

(73) Assignee: STMicroelectronics International N.V., Geneva (CH)

(21) Appl. No.: 19/407,256

(22) Filed: Dec. 3, 2025

(30) Foreign Application Priority Data
Dec. 5, 2024 (FR) FR2413519

(51) Int. Cl. H02M 7/08; H02J 7/00; H02J 50/27; H02M 7/219; H02M 7/23

(52) U.S. Cl. CPC H02M 7/08; H02J 7/933; H02J 50/27; H02M 7/219; H02M 7/23; H02J 2207/20

(57) ABSTRACT

A rectifier includes a first terminal coupled to an output via a component and a second terminal coupled to the output via a component. A transistor has a first node coupled to the first terminal and a second node coupled to a voltage rail. A voltage comparator has an input coupled to the first node of the transistor, an input coupled to the second node of the transistor, and an output coupled to the gate of the transistor. Another transistor has a first node coupled to the second terminal and a second node coupled to the voltage rail. Another voltage comparator has an input coupled to the first node of the other transistor, an input coupled to the second node of the other transistor, and an output coupled to the gate of the other transistor.

### PRIORITY CLAIM

This application claims the priority benefit of French Application for Patent No. FR2413519, filed on Dec. 5, 2024, the content of which is hereby incorporated by reference in its entirety to the maximum extent allowable by law.

### TECHNICAL FIELD

The present disclosure generally concerns a current rectifier and a method of using a current rectifier.

### BACKGROUND

A current rectifier is configured to convert an alternating current into a direct current. Each of the components of a current rectifier can be optimized for a specific value of the current to be supplied. The power transmission of a current rectifier can thus also be optimized for a value of the current to be supplied. However, it may be useful to use a current rectifier over a relatively wide range of current values.

There exists a need for a current rectifier with an improved power transmission over a relatively wide range of current values.

### SUMMARY

In an embodiment, a circuit comprises at least two rectifiers coupled in parallel between a first terminal and a second terminal, the circuit being configured to disconnect at least one of the rectifiers based on a direct current flowing through a conductive output line.

In an embodiment, a rectifier, comprises: a first terminal coupled to an output conductive line via a first component and a second terminal coupled to the output conductive line via a second component; a first transistor comprising a first connection node coupled to the first terminal and a second connection node coupled to a voltage rail; a first voltage comparator comprising a first input coupled to the first connection node of the first transistor, a second input coupled to the second connection node of the first transistor, and an output coupled to the gate of the first transistor; a second transistor comprising a first connection node coupled to the second terminal and a second connection node coupled to the voltage rail; a second voltage comparator comprising a first input coupled to the first connection node of the second transistor, a second input coupled to the second connection node of the second transistor, and an output coupled to the gate of the second transistor; and at least one assembly of components, each component assembly being formed of: a third component coupled between the first terminal and the output conductive line; a fourth component coupled between the second terminal and the output conductive line; a third transistor comprising a first connection node coupled to the first terminal and a second connection node coupled to the voltage rail; and a fourth transistor comprising a first connection node coupled to the second terminal and a second connection node coupled to the voltage rail.

According to an embodiment, each assembly further comprises at least one switch configured to enable or to prevent the operation of the third and fourth components.

According to an embodiment, the rectifier is configured to generate a direct output current and further comprises a detection circuit configured to detect the intensity of the direct current and to control the at least one switch based on the intensity of the detected direct current.

According to an embodiment, the rectifier further comprises: a first diode coupled between the voltage rail and the first terminal; and a second diode coupled between the voltage rail and the second terminal.

According to an embodiment, the first voltage comparator is configured to deliver a voltage such that the first transistor is on when the alternating current flowing from the first terminal to the second terminal is greater than a threshold current, and the second voltage comparator is configured to deliver a voltage such that the first transistor is on when the alternating current flowing from the second terminal to the first terminal is greater than the threshold current.

According to an embodiment, the first and second components are transistors having channels of a first conductivity type.

According to an embodiment, the first transistor and the second transistor are transistors having channels of a second conductivity type opposite to the first conductivity type.

According to an embodiment, the first component and the second component are p-channel MOS transistors, and the first transistor and the second transistor are n-channel MOS transistors.

Another embodiment provides a wireless electronic device comprising: the above-mentioned rectifier; an antenna circuit configured to generate the alternating current, the antenna circuit comprising an antenna configured to communicate in wireless fashion; and a battery configured to be charged from a direct current generated by the rectifier.

Another embodiment provides a method of using a circuit comprising at least two rectifiers connected in parallel between a first terminal and a second terminal, the method comprising: disconnecting at least one of the rectifiers based on a direct current flowing through a conductive output line.

Another embodiment provides a method of using a rectifier comprising, when the alternating current is in a positive phase and flows from the first terminal of the rectifier to the second terminal of the rectifier: the control of a first voltage on a gate of a first transistor by a first voltage comparator having a first input coupled to a first connection node of the first transistor and a second input coupled to a second connection node of the first transistor, the first voltage being configured so that the first transistor is off; the control of a second voltage on a gate of a second transistor by a second voltage comparator having a first input coupled to a first connection node of the second transistor, and a second input coupled to a second connection node of the second transistor, the second voltage being configured so that the second transistor is on and the alternating current flows between a first connection node and a second connection node of the second transistor; the transmitting of the alternating current from the first terminal of the rectifier to an output conductive line via a first component; the control of the first voltage on a gate of at least one third transistor by the first voltage comparator, the first voltage being configured so that the at least one third transistor is off; the control of the second voltage on a gate of at least one fourth transistor by the second voltage comparator, the second voltage being configured so that the at least one fourth transistor is on and the alternating current flows between a first connection node and a second connection node of the at least one fourth transistor; and the transmitting of the alternating current from the first terminal of the rectifier to an output conductive line via at least one third component.

The method of using the rectifier further comprises, when the alternating current is in a negative phase: the control of the first voltage on the gate of the first transistor by the first voltage comparator, the first voltage being configured so that the first transistor is on and that the alternating current flows between a first connection node and a second connection node of the first transistor; the control of the second voltage on the gate of the second transistor by the second voltage comparator, the second voltage being configured so that the second transistor is off; the transmitting of the alternating current from the second terminal of the rectifier to the output conductive line via a second component; the control of the first voltage on the gate of the at least one third transistor by the first voltage comparator, the first voltage being configured so that the at least one third transistor is on and that the alternating current flows between a first connection node and a second connection node of the at least one third transistor; the control of the second voltage on the gate of the at least one fourth transistor by the second voltage comparator, the second voltage being configured so that the at least one fourth transistor is off; and the transmitting of the alternating current from the second terminal of the rectifier to the output conductive line via at least one fourth component, each third component, each fourth component, each third transistor, and each fourth transistor forming a component assembly.

According to an embodiment, the method of using a rectifier further comprises controlling at least one switch to enable or prevent the operation of the third and fourth components.

According to an embodiment, the method of using a rectifier further comprises: generating a direct current at the rectifier output; detecting, by means of a detection circuit, the intensity of the direct current; and controlling the at least one switch to enable the operation of the third and fourth components when the direct current exceeds a threshold current.

According to an embodiment, the first and second voltages are generated so that the first transistor, the second transistor, the third transistor, and the fourth transistor are enabled when the alternating current is greater than a threshold current.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows a wireless charging system between two devices;

FIG. 2 shows, in more detail, a portion of the system of FIG. 1;

FIG. 3 is a graph illustrating a current and voltages of the circuit of FIG. 2 as a function of time during the charging of a battery;

FIG. 4 shows an example of an electronic circuit of a rectifier;

FIG. 5 shows an example of an electronic circuit of a rectifier;

FIG. 6 shows an example of an electronic circuit of a rectifier; and

FIG. 7 shows an example of an electronic circuit of a rectifier.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, near-field communication systems and wireless device charging systems are assumed to be known to those skilled in the art. The methods of manufacturing electronic components such as a diode, a transistor, or a voltage comparator, as well as their operation, are also assumed to be known to those skilled in the art.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings in a normal position of use.

Unless specified otherwise, the expressions “about”, “approximately”, “substantially”, and “in the order of” signify plus or minus 10%, preferably of plus or minus 5%.

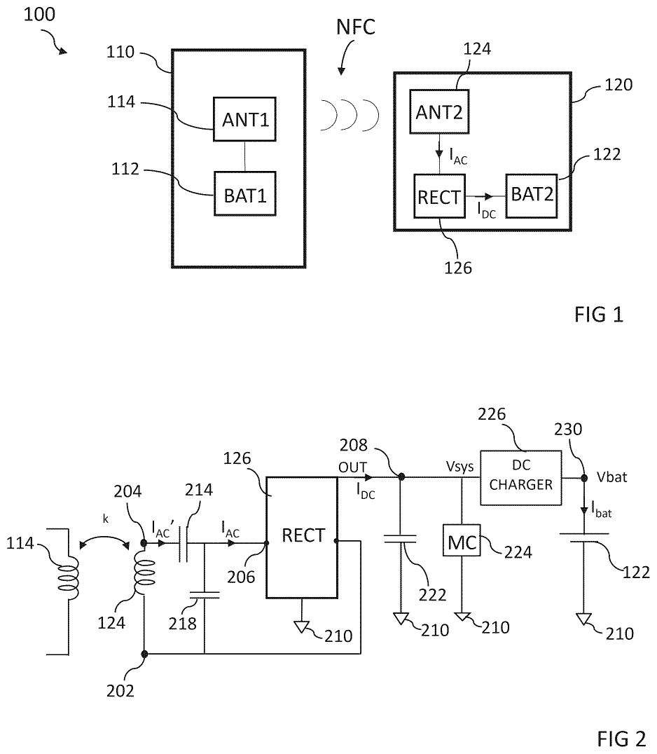

FIG. 1 shows a wireless charging system 100 between a first device 110 and a second device 120.

First device 110 is, for example, a cell phone, a tablet computer, an external charge battery. First device 110 comprises a battery 112 (“BAT1”) coupled to an antenna 114 (“ANT1”) and is, for example, configured to communicate in wireless fashion. In the example of FIG. 1, a near-field communication (“NFC”), for example 13.56-MHz NFC, is shown. In other examples, not shown, a Qi communication or any other type of wireless communication is used. First device 110, via antenna 114, for example comprised in a transmitter not detailed in FIG. 1, is configured to charge a battery 122 (“BAT2”) of second device 120, by wireless charging (WLC). Battery 122 is, for example, a lithium-ion, lithium-polymer, etc., battery.

Second device 120 is, for example, a cell phone, an accessory, such as connected headphones or a connected cell phone protective shell, a tablet computer, etc. Second device 120 comprises an antenna 124 (“ANT2”) configured to receive an electromagnetic field transmitted from the antenna 114 of first device 110. Antenna 124 is further configured to generate an alternating electric current I_{AC} from the received electromagnetic field.

Antenna 124 is connected to battery 122 via a current rectifier 126 (“RECT”). Rectifier 126 is configured to convert the alternating electric current I_{AC} into a direct electric current I_{DC}. Direct electric current I_{DC} contributes, for example, to charging the battery 122 of second device 120.

However, if direct electric current I_{DC} is constant, irrespective of the state of charge (SoC) of battery 122, then a relatively accelerated ageing or risk of damage to battery 122 is possible. To avoid this, second device 120 is configured, for example, to ask first device 110 to vary the power of the emitted field in order to adapt the level of the generated direct electric current I_{DC}.

According to an aspect, to improve the efficiency of the charging of second device 120 by first device 110 and to protect and improve the lifetime of the battery 122 of second device 120, there is provided a current rectifier having an efficiency and a performance which are relatively high over a relatively wide range of current values. According to an aspect, there is provided a current rectifier comprising a plurality of circuits, each circuit being capable of being used over a given current range.

FIG. 2 shows, in more detail, a portion of the system 100 of FIG. 1. In particular, FIG. 2 shows the antenna 114 of the first device 100 of FIG. 1 and an example of the battery charging circuit 122 of the second device 120 of FIG. 1, comprised in second device 120. The antenna 124 of second device 120 comprises a first connection node 202 and a second connection node 204.

During the charging of battery 122 by wireless charging, antenna 114 and antenna 124 are, for example, coupled with a coupling coefficient k. An alternating electric current I_{AC} ′ is thus generated at the connection nodes of antenna 124 having first phases corresponding to a first conduction direction, said to be positive, in antenna 124 and second phases corresponding to a second conduction direction, opposite to the first direction and said to be negative, in antenna 124. Second device 120, depending on the state of charge of battery 122, communicates for example with first device 110, for example by electromagnetic field modulation according to an NFC protocol, so that it modifies a power transmitted by antenna 114 and the value of the generated current I_{AC}.

Rectifier 126 (“RECT”) comprises a first input/output node 206, a second input/output node coupled to node 202, and a third connection node, for example an output (“OUT”), coupled to an output conductive line 208 (“output line”). Rectifier 126 is also coupled to a voltage rail 210, for example a ground rail.

In the example of FIG. 2, rectifier 126 is configured to convert the alternating current I_{AC} received on its first and second inputs/outputs into the direct current I_{DC} described in relation with FIG. 1, generated on output conductive line 208.

The connection node 202 of antenna 124 is, for example, coupled to the input/output node 206 of rectifier 126 via a capacitor 218. The connection node 204 of antenna 124 is, for example, coupled to the input/output node 206 of rectifier 126 via a capacitor 214.

Capacitor 218 is, for example, configured to develop a voltage across rectifier 126, for example to enable rectifier 126 to operate at relatively low field or low coupling. Capacitor 214 is, for example, used to transmit a relatively high field or high coupling energy.

The output OUT of rectifier 126 and output conductive line 208 are, for example, coupled to ground rail 210 via a capacitor 222. Capacitor 222 is, for example, configured to apply a low-pass filter to a DC voltage Vsys of output conductive line 208 and/or to store charges collected at antenna 124.

As an example, a circuit 224 is coupled between output conductive line 208 and voltage rail 210. Circuit 224 is, for example, a measurement circuit (MC) configured to perform a measurement of the value of the voltage of output conductive line 208 relative to voltage rail 210 and to consume the current originating from rectifier 126, for example so as not to exceed a set point voltage. Circuit 224 limits, for example, the voltage so as not to exceed a threshold voltage, for example specific to a manufacturing process technology. The set point voltage is, for example, adjusted over time, for example as a function of the state of charge of battery 122. Circuit 224 consumes, for example, an excess current received at antenna 124 so as not to exceed the set point voltage. Device 120 communicates, for example, with device 110 so that device 110 adjusts a power transmitted via antenna 114, for example to decrease the excess current, for example to save energy.

The output OUT of rectifier 126 is further coupled to battery 122, for example via a charger 226 (“DC CHARGER”). Charger 226 is coupled between output conductive line 208 and a node 230 and is, for example, configured to receive DC voltage Vsys and direct current I_{DC} and is, for example, configured to generate a current I_{bat} at node 230. The value of current I_{bat} depends, for example, on the state of charge of battery 122.

Battery 122 has a voltage Vbat across its terminals, that is, between node 230 and voltage rail 210 in the example of FIG. 2. The charging of battery 122, that is, the variation of Vbat over time, is controlled by charger 226 and in particular by the current I_{bat} generated over time.

According to an embodiment, the voltage of voltage rail 210 is constant over time, while the voltage Vsys of output conductive line 208 is variable over time. The voltage Vsys of output conductive line 208 varies, for example, as a function of the state of charge of battery 122, that is, as a function of the ratio of voltage Vbat to a maximum charging voltage.

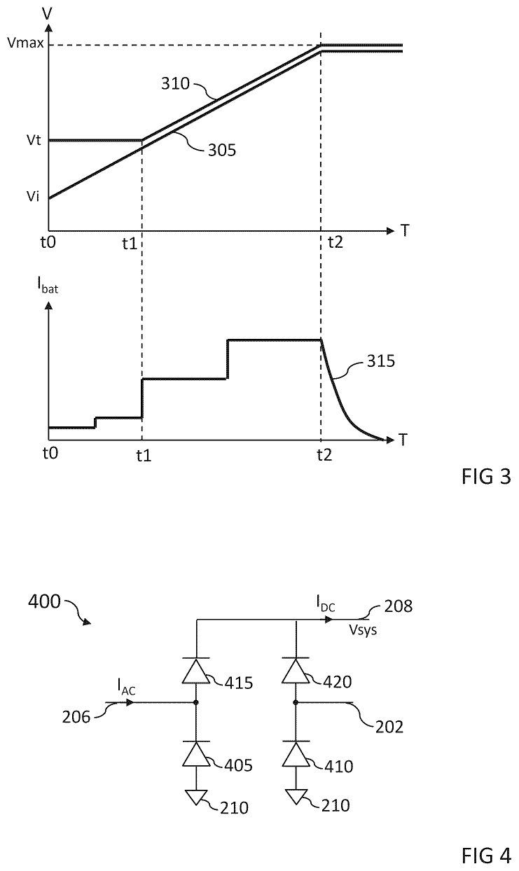

FIG. 3 is a graph showing the current I_{bat} and voltages (“V”) Vsys and Vbat of the circuit of FIG. 2 as a function of time (“T”) during the charging of battery 122, according to an embodiment of the present disclosure.

A curve 305 represents the variation of voltage Vbat, a curve 310 represents the variation of voltage Vsys, and a curve 315 represents current I_{bat}.

In the example of FIG. 3, battery 122 has a low initial voltage Vi thereacross at a time t0. Battery 122 is recharged by the circuit described in relation with FIG. 2 over time.

In the example of FIG. 3, when the battery 122 described in relation with FIGS. 1 and 2 is lightly charged, between t0 and a time t1, t1 being greater than t0, voltage Vsys is, for example, constant and equal to a voltage Vt. Voltage Vt is, for example, in the range from 0.1 V to 0.4 V and preferably approximately equal to 0.2 V. The charging of battery 122 is then current-controlled. The charger 226 of second device 120, described in relation with FIG. 2, is for example configured to control the value of current I_{bat} as a function of voltage Vbat. In the example of FIG. 3, curve 315 then follows a stepped function.

As a consequence of the received current I_{bat}, battery 122 charges and voltage Vbat increases. Curve 305 follows, for example, an affine function. Voltage Vbat is, for example, smaller than or equal to voltage Vsys.

At time t1, voltage Vbat is for example close to voltage Vsys, for example equal to Vsys-δ, with δ a voltage in the range from 0 V to 0.1 V. Voltage δ corresponds, for example, to an operating voltage of charger 226. For example, charger 226 dissipates an energy equal to voltage δ multiplied by a charging current of charger 226. The more significant voltage δ, the more significant the dissipated energy. According to an embodiment, the set point voltage of circuit 224 described in relation with FIG. 2 is configured so that voltage Vsys follows the variations of Vbat with voltage δ having a relatively low value.

Between time t1 and a time t2, t2 being greater than t1, voltage Vsys is in the range from Vt to a maximum voltage Vmax. Voltage Vmax is, for example, in the range from 3.6 V to 6 V and preferably from 4 V to 4.4 V, for example equal to approximately 4.2 V. In the example of FIG. 3, curve 310 follows an affine function taking value Vt at time t1 and taking value Vmax at time t2. The charging of battery 122 is, for example, current-controlled. Charger 226 is, for example, configured to control the value of current I_{bat} as a function of voltage Vbat. In the example of FIG. 3, curve 315 follows a stepped function.

According to other embodiments, not shown, curve 315 is a continuous function, for example an affine or logarithmic function, between t0 and t2.

As a consequence of the received current I_{bat}, battery 122 charges and voltage Vbat increases. The variation of voltage Vsys follows, for example, the variation of voltage Vbat. For example, Vbat=Vsys−δ.

At time t2, voltage Vsys reaches maximum voltage Vmax, and voltage Vsys for example becomes constant. Voltage Vbat is, for example, then relatively close to the maximum charging voltage. The charging of battery 122 is then voltage-controlled in order to keep Vsys and Vbat smaller than or equal to Vmax. Current I_{bat} is then decreased, for example via charger 226, to control voltage Vbat and keep it close to the maximum charging voltage. Curve 315 is, for example, decreasing after t2. Curve 315 follows, for example, an exponential, logarithmic, etc., decrease.

As a variant, voltage Vsys is constant and approximately equal to Vmax over the entire duration of the charging of battery 122.

An advantage of varying voltage Vsys is to decrease the power consumption of the device 120 of FIG. 1 and to optimize the charging of device 120.

An advantage of varying current I_{bat} is to limit the aging of battery 122 and to decrease the risk of damage to battery 122. In particular, between t0 and t1 and between t1 and t2, a high value of I_{bat} decreases the lifetime of battery 122, causes a drop in the reliability of battery 122, and battery 122 has a greater risk of catching fire.

FIG. 4 shows an example of an electronic circuit 400 of a rectifier. Some elements of FIG. 4 correspond to elements of FIG. 2, these elements are designated with the same reference numerals and are not detailed again.

Electronic circuit 400 comprises, for example, a first diode 405 and a second diode 410 coupled between voltage rail 210 and respectively node 206 and node 202. Electronic circuit 400 comprises, for example, a third diode 415 and a fourth diode 420 coupled between output conductive line 208 and respectively node 206 and node 202.

The alternating current I_{AC} of FIGS. 1 and 2, received by the rectifier, flows between node 202 and 206. During the first phases described in relation with FIG. 2, current I_{AC} is in a positive phase and flows from node 206 to node 202. In the second phases described in relation to FIG. 2, current I_{AC} is in a negative phase and flows from node 206 to node 202.

During the first phases, diodes 405, 410, 415, and 420 are, for example, configured so that the current flows through diodes 410 and 415 in the forward direction and does not flow through diodes 405 and 420.

During the second phases, diodes 405, 410, 415, and 420 are, for example, configured so that the current flows through diodes 405 and 420 in the forward direction and does not flow through diodes 410 and 415.

During the first and second phases, the current I_{DC} flowing at the rectifier output, that is, at output conductive line 208, is a positive direct current.

It is known to optimize the power transmission efficiency of circuit 400, between nodes 202 and 206 and output conductive line 208, around a current value. However, it is preferable to vary the value of I_{DC} over a relatively wide range of values during the charging of battery 122.

FIG. 5 shows an example of an electronic circuit 500 of the rectifier 126 of FIGS. 1 and 2. Certain elements of FIG. 5 correspond to elements of FIG. 2, these elements are designated with the same reference numerals and are not detailed again.

Electronic circuit 500 comprises, for example, a first transistor 505 of a first type and a second transistor 510 of the first type coupled between output conductive line 208 and respectively node 206 and node 202. The transistors 505 and 510 of the first type have channels of a first conductivity type. In the example of FIG. 5, transistors 505 and 510 are of p-channel MOS (pMOS) type. A gate of transistor 505 is, for example, coupled to node 202 and a gate of transistor 510 is, for example, coupled to node 206 (such that the pair of transistors 505, 510 are connected in a cross-coupled relationship).

Electronic circuit 500 comprises, for example, a first transistor 515 of a second type, opposite to the first type, coupled between node 206 and voltage rail 210, and a second transistor 520 of the second type coupled between node 202 and voltage rail 210. The transistors 515 and 520 of the second type have channels of a second conductivity type opposite to the first conductivity type. In the example of FIG. 5, transistors 515 and 520 are of n-channel MOS (nMOS) type.

Electronic circuit 500 comprises, for example, a first voltage comparator 525 having a negative input coupled to node 206, a positive input coupled to voltage rail 210, and an output coupled, for example, to a gate of transistor 515. Electronic circuit 500 comprises, for example, a second voltage comparator 530 having a negative input coupled to node 202, a positive input coupled to voltage rail 210, and an output coupled, for example, to a gate of transistor 520.

Components 505, 510, 515, 520, 525 and 530 for example form a first rectifier.

Electronic circuit 500 comprises, for example, a first diode 535 coupled in the forward direction between voltage rail 210 and node 206, that is, having its anode coupled to voltage rail 210 and its cathode coupled to node 206. Electronic circuit 500 comprises, for example, a second diode 540 coupled in the forward direction between voltage rail 210 and node 202, that is, having its anode coupled to voltage rail 210 and its cathode coupled to node 202.

Electronic circuit 500 comprises, for example, a third transistor 541 of the first type, pMOS in the example of FIG. 5, and a fourth transistor 543 of the first type, coupled between output conductive line 208 and respectively node 206 and node 202. A gate of transistor 541 is for example coupled to node 202 by a switch 542 and is further coupled to output conductive line 208 via a switch 544. A gate of transistor 543 is, for example, coupled to node 206 via a switch 546 and is further coupled, for example, to output conductive line 208 via a switch 548. The pair of transistors 541, 543 are thus connected in a switched cross-coupled relationship where the switches 542, 544, 546, 548 are controlled to enable/disable the transistors 541, 542 in response to control signal(s) from the circuit 224.

Electronic circuit 500 comprises, for example, a third transistor 550 of the second type, nMOS in the example of FIG. 5, coupled between node 206 and voltage rail 210. Electronic circuit 500 comprises, for example, a fourth transistor 555 of the second type coupled between node 202 and voltage rail 210.

The gate of transistor 550 is, for example, coupled to the output of a first “AND” logic gate 552, taking, for example, at a first input, the output of comparator 525 and, at a second input, a control signal EN. Control signal EN is configured, for example, to take one of two voltage values, configured to turn third transistor 550 on or off. The gate of transistor 555 is, for example, coupled to the output of a second “AND” logic gate 557, taking, for example, at a first input, the output of comparator 530 and, at a second input, control signal EN. These two connections are not shown in FIG. 5 for the sake of clarity.

Components 541, 543, 550 and 555 for example form a second rectifier 560. The second rectifier 560 for example further comprises switches 542, 544, 546, and 548. Switches 542, 544, 546, and 548 are for example configured to disconnect the second rectifier 560, for example based on the direct current IDC flowing through the output conductive line 208.

Electronic circuit 500 comprises, for example, an assembly of components 560 formed of transistors 541, 543, 550, 555, of switches 542, 544, 546, and 548, and of logic gates 552 and 557, represented by a dashed outline in FIG. 5.

Switches 542, 544, 546, and 548 and control signal EN are, for example, controlled by a control circuit of second device 120, not shown in FIG. 5, and are configured to control the flowing of current I_{AC} through transistors 541, 543, 550, and 555. In other embodiments, switches 542, 544, 546, and 548 are replaced by at least one switch configured to enable or to prevent the operation of transistors 541, 543, 550, 555.

For example, circuit 224 is configured to detect the intensity of direct current I_{DC} and to control one or more of switches 542, 544, 546, and 548 and/or control signal EN based on the intensity of the detected direct current (I_{DC}).

During the first phases, current I_{AC} flows from node 206 to node 202, and is said to be positive. During second phases, current I_{AC} flows from node 206 to node 202, and is said to be negative.

The first comparator 525 and the second comparator 530 are configured, for example, to detect a current flowing through transistor 515 and transistor 520 respectively, as a function of the voltage difference measured between the positive input and the negative input of each of the comparators. Comparators 525 and 530 are each respectively configured to deliver a voltage VD1 and VD2 so that transistors 515 and 520 respectively turn on, when the measured voltage difference corresponds to a current I_{AC} having a value greater than a threshold current Iₜₕ. Threshold current Iₜₕ is, for example, in the range from 0 to 100 μA.

Transistors 515 and 520 are configured for example to have, when they are on, a less resistive channel than diodes 535 and 540, respectively.

In the example of FIG. 5, during the first phases of current I_{AC}, if current I_{AC} has a value greater than threshold current Iₜₕ: comparator 525 is, for example, configured to generate voltage VD1 having a value such that transistor 515 is off; comparator 530 is, for example, configured to generate voltage VD2 having a value such that transistor 520 is on; current I_{AC} flows, for example, through transistor 520 from voltage rail 210 to node 202; node 202 is, for example, at a low voltage, close to 0 V; current I_{AC} flows, for example, through transistor 505, from node 206 to output conductive line 208; node 206 is, for example, at a high voltage, for example close to voltage Vsys; diode 535 is,, for example biased so as to be non-conductive, for example because node 206 is at a higher voltage than voltage rail 210; transistor 520 is configured, for example, to have a less resistive channel than diode 540, and the current thus does not flow through diode 540.

During the second phases of current I_{AC}, if current I_{AC} has a value greater than threshold current Iₜₕ: comparator 525 is configured, for example, to generate voltage VD1 having a value such that transistor 515 is on; comparator 530 is configured, for example, to generate voltage VD2 having a value such that transistor 520 is off; current I_{AC} flows through transistor 515, for example, from voltage rail 210 to node 206; node 206 is, for example, at a low voltage, close to 0 V; current I_{AC} flows, for example, through transistor 510, from node 202 to output conductive line 208; node 202 is, for example, at a high voltage, close to voltage Vsys; diode 540 is for example biased to be non-conductive, for example because node 202 is at a higher voltage than voltage rail 210; transistor 515 is, for example, configured to have a less resistive channel than diode 535, and the current thus does not flow through diode 535.

The power lost through the rectifier of FIG. 4, when current I_{AC} has a value greater than threshold current Iₜₕ, and the switches of assembly 560 are configured so that current I_{AC} does not flow through any of the transistors of assembly 560, is given by: P=R_{(DS})·I_{AC}² with R_{DS} the equivalent resistance of each of transistors 515 and 520 in the on mode. In the example of FIG. 5, switches 542 and 546 are off, control signal EN is configured so that transistors 550 and 555 are off and switches 544 and 548 are on.

In order to reduce power loss as current I_{AC} increases, assembly 560 is, for example, configured so that current I_{AC} flows through the transistors 541 and 555 of assembly 560 during the first phases, and through the transistors 543 and 550 of assembly 560 during the second phases. In the example of FIG. 5, switches 542 and 546 are for example on, control signal EN is configured so that transistors 550 and 555 are on and switches 544 and 548 are for example off. One then has transistors 505 and 541 in parallel, transistors 510 and 543 in parallel, transistors 515 and 550 in parallel, and transistors 520 and 555 in parallel. The power lost through the rectifier is then given by: P=R_{DS}/2·I_{AC}².

According to embodiments not shown, assembly 560 is repeated a plurality of times, and switches of each of the assemblies are controlled to progressively increase the number of transistors in parallel as a function of current I_{AC}. For a number n of repeated assemblies 560, the power lost through the rectifier is then given by: P=R_{DS}/(n+1)·I_{AC}². These embodiments have the advantage of making circuit 500 more scalable and of increasing the efficiency of circuit 500 as a function of current I_{AC}.

In the example of FIG. 5, during the first phase, if current I_{AC} has a value smaller than threshold current Iₜₕ: comparator 525 is, for example, configured to generate voltage VD1 having a value such that transistor 515 is off; comparator 530 is, for example, configured to generate voltage VD2 having a value such that transistor 520 is off; current I_{AC} flows through diode 540, for example, from voltage rail 210 to node 202; node 202 is, for example, at a low voltage, close to 0 V; current I_{AC} flows, for example, through transistor 505, from node 206 to output conductive line 208; node 206 is, for example, at a high voltage, close to voltage Vsys; diode 535 is, for example, biased so as to be non-conductive; the switches of assembly 560 are, for example, configured so that current I_{AC} does not flow through any of the transistors in assembly 560.

During the second phase, if current I_{AC} has a value lower than threshold current Iₜₕ: comparator 525 is, for example, configured to generate voltage VD1 having a value such that transistor 515 is off; comparator 530 is, for example, configured to generate voltage VD2 having a value such that transistor 520 is off; current I_{AC} for example flows through diode 535, for example, from voltage rail 210 to node 206; node 206 is, for example, at a low voltage, close to 0 V; current I_{AC} flows, for example, through transistor 510, from node 202 to output conductive line 208; node 202 is, for example, at a high voltage, close to the voltage Vsys; diode 540 is, for example, biased so as to be non-conductive; the switches in assembly 560 are configured, for example, so that current I_{AC} does not flow through any of the transistors in assembly 560. Capacitor 218, described in relation with FIG. 2, creates, for example, a voltage across its terminals with a current originating from antenna 124. This voltage causes, for example, a voltage at node 206 and/or at node 202 to be higher than a voltage at node 210. Diodes 535 and 540 are thus on.

The power lost through the rectifier of FIG. 4 is given by: P=Vd·I_{AC} with Vd a threshold voltage of diodes 535 and 540. For example, Vd is approximately equal to 0.6 V.

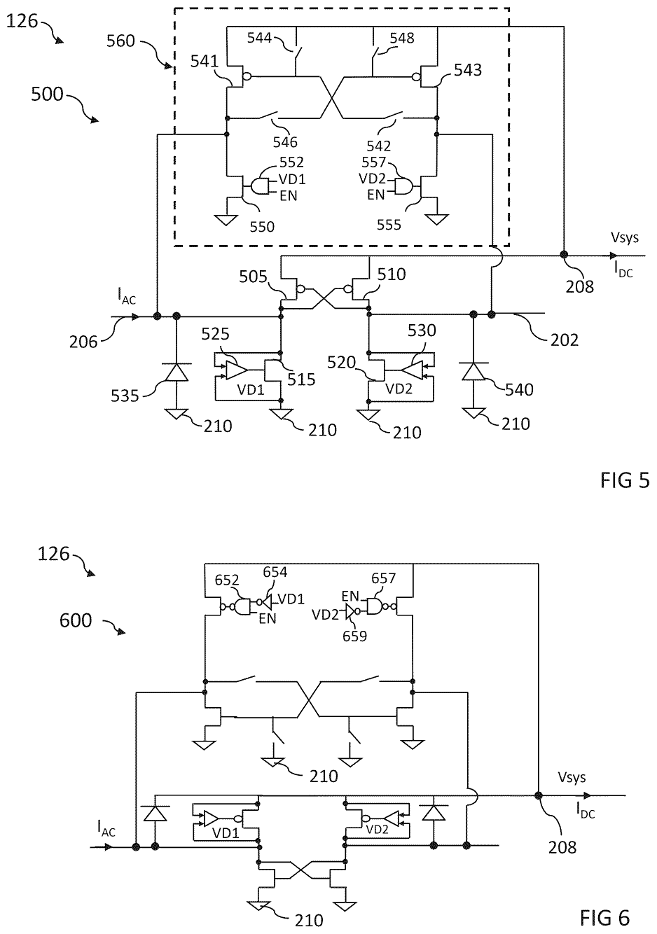

FIG. 6 shows another example of an electronic circuit 600 of the rectifier 126 of FIGS. 1 and 2. Electronic circuit 600 is similar to electronic circuit 500. Electronic circuit 600 differs from electronic circuit 500 essentially in that the transistors of the first type in circuit 500 are transistors of the second type in circuit 600, and the transistors of the second type in circuit 500 are transistors of the first type in circuit 600. Further, the output conductive line 208 in circuit 500 becomes the voltage rail 210 in circuit 600, and the voltage rail 210 in circuit 500 becomes the output conductive line 208 in circuit 600. The first “AND” logic gate 552 and the second “AND” logic gate 557 are replaced by a first “NAND” logic gate 652 and a second “NAND” logic gate 657 respectively. A first “NO” logic gate 654 is added, logic gate 654 having an output coupled to a first input of logic gate 652 and an input coupled to the output of comparator 525. A second “NO” logic gate 659 is added, logic gate 659 having an output coupled to a first input of logic gate 657 and an input coupled to the output of comparator 530. Logic gates 652, 654, 657, and 659 are configured to adapt the signals to the operation of transistors of the first type.

The operation of circuit 600 is similar to the operation of circuit 500.

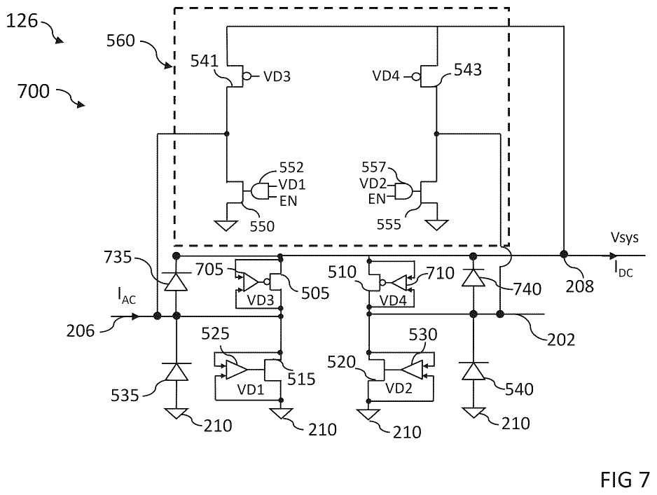

FIG. 7 shows an example of electronic circuit 700 of the rectifier 126 of FIGS. 1 and 2. Electronic circuit 700 is similar to the electronic circuit 500 of FIG. 5. Some elements of FIG. 7 are identical to elements of FIG. 5 and will not be described in detail. Electronic circuit 700 differs from electronic circuit 500 essentially in that the transistors 505 and 510 of the first type in circuit 500 each have their gate coupled to a comparator in circuit 700, instead of being coupled to nodes 202, 206.

In particular, electronic circuit 700 comprises, for example, a comparator 705 having a negative input coupled to output conductive line 208, a positive input coupled to node 206, and an output coupled to the gate of transistor 505 and to the gate of transistor 541. Electronic circuit 700 comprises, for example, a comparator 710 having a negative input coupled to output conductive line 208, a positive input coupled to node 202, and an output coupled to the gate of transistor 510 and to the gate of transistor 543. Comparator 705 generates an output voltage VD3 and comparator 710 generates an output voltage VD4. Circuit 700 further comprises a third diode 735 coupled in the forward direction between node 206 and node 208, that is, having its anode coupled to node 206 and its cathode coupled to node 208. Electronic circuit 700 further comprises a fourth diode 740 coupled in the forward direction between node 202 and node 208, that is, having its anode coupled to node 202 and its cathode coupled to node 208. Diodes 735 and 740 are configured to have an operation similar to that of diodes 535 and 540. In particular, when transistors 505 and 510 are configured to be on, the current does not flow through diodes 735 and 740.

The operation of circuit 700 is similar to the operation of circuit 500.

Further, electronic circuit 700 differs from electronic circuit 500 in that circuit 700 does not comprise switches 542 to 548. The number of transistors simultaneously on, and coupled in parallel, is controlled, for example, by a modulation of the gate voltages of the transistors.

An advantage of the various described circuit implementation is that current rectifier circuit 126 adapts to the value of the alternating current I_{AC} received in order to optimize the efficiency of rectifier 126. For example, a charging of the battery 122 of second device 120 consumes less energy of the battery 112 of the first device 110 of FIG. 1. The various embodiments allow an optimum charging of battery 122 by varying the value of the current and/or voltage across the battery, for example as a function of its state of charge. An advantage of a communication between second device 120 and first device 110 is to vary the power transmitted from the first device to the second device, and to avoid the need to transmit a maximum power at all times.

An advantage of an NFC wireless communication is the use of smaller antennas than for a communication at a lower frequency. Space is thus saved in first device 110 and in second device 120.

Although in the described embodiments, rectifier 126 is used in a wireless battery recharging system, in other embodiments, rectifier 126 is, for example, comprised in a contactless device, for example a contactless payment card, for example a contactless device using current to perform energy harvesting.

Various embodiments and variants have been described. Those skilled in the art will understand that certain features of these various embodiments and variants may be combined, and other variants will occur to those skilled in the art. In particular, although transistors 505, 510, 541, 543 of the first type have been described, the transistors of the first type are, for example, replaced by diodes, coupled in on mode from node 206 or 202 to output conductive line 208, in the example of FIG. 5. Although two diodes 535, 540 are described in the example of FIG. 5, they may be replaced by two body diodes of two transistors of the second type.

Finally, the practical implementation of the described embodiments and variants is within the abilities of those skilled in the art based on the functional indications given hereabove.

1. A circuit, comprising:
at least two rectifiers connected in parallel between a first terminal and a second terminal;
wherein the circuit is configured to disconnect at least one of the rectifiers based on a direct current flowing through a conductive output line.

2. The circuit according to claim 1, wherein a first rectifier of said at least two rectifiers comprises:
the first terminal coupled to the output conductive line via a first component;
the second terminal coupled to the output conductive line via a second component;
a first transistor comprising a first connection node coupled to the first terminal and a second connection node coupled to a voltage rail;
a first voltage comparator comprising a first input coupled to the first connection node of the first transistor, a second input coupled to the second connection node of the first transistor, and an output coupled to the gate of the first transistor;
a second transistor comprising a first connection node coupled to the second terminal and a second connection node coupled to the voltage rail; and
a second voltage comparator comprising a first input coupled to the first connection node of the second transistor, a second input coupled to the second connection node of the second transistor, and an output coupled to the gate of the second transistor; and
wherein a second rectifier of said at least two rectifiers comprises:
a third component coupled between the first terminal and the output conductive line;
a fourth component coupled between the second terminal and the output conductive line;
a third transistor comprising a first connection node coupled to the first terminal and a second connection node coupled to the voltage rail; and
a fourth transistor comprising a first connection node coupled to the second terminal and a second connection node coupled to the voltage rail.

3. The circuit according to claim 2, wherein the first component and the second component are transistors having channels of a first conductivity type, and wherein the first transistor and the second transistor are transistors having channels of a second conductivity type opposite to the first conductivity type.

4. The circuit according to claim 2, wherein the second rectifier further comprises at least one switch configured to enable or prevent the operation of the third and fourth components, and wherein the direct current is generated at an output, and further comprising a detection circuit configured to detect an intensity of the direct current and to control the at least one switch based on the detected intensity of the direct current.

5. The circuit according to claim 2, wherein:
the first voltage comparator is configured to generate an output voltage applied to turn on the first transistor when the alternating current flowing from the first terminal to the second terminal is greater than a threshold current; and
the second voltage comparator is configured to generate an output voltage applied to turn on the second transistor when the alternating current flowing from the second terminal to the first terminal is greater than the threshold current.

6. The circuit according to claim 1, further comprising:
a first diode coupled between a voltage rail and the first terminal; and
a second diode coupled between the voltage rail and the second terminal.

7. A wireless electronic device, comprising:
the circuit according to claim 1;
an antenna circuit configured to generate an alternating current, the antenna circuit comprising an antenna configured to communicate in wireless fashion; and
a battery configured to be charged from a direct current generated by the rectifier.

8. A method of rectifying using a circuit comprising at least two rectifiers connected in parallel between a first terminal and a second terminal, the method comprising disconnecting at least one rectifier of the at least two rectifiers based on a direct current flowing through a conductive output line.

9. The method according to claim 8, further comprising:
when an alternating current input is in a positive phase and flows from a first terminal to a second terminal:
controlling a first voltage on a gate of a first transistor to turn the first transistor off using a first voltage comparator having a first input coupled to a first connection node of the first transistor and a second input coupled to a second connection node of the first transistor;
controlling a second voltage on a gate of a second transistor to turn the second transistor on using a second voltage comparator having a first input coupled to a first connection node of the second transistor, and a second input coupled to a second connection node of the second transistor, wherein the alternating current flows between the first connection node and the second connection node of the second transistor;
transmitting the alternating current from the first terminal of the rectifier to an output conductive line via a first component;
controlling by the first voltage comparator the first voltage on a gate of at least one third transistor to turn the at least one third transistor off;
controlling by the second voltage comparator the second voltage on a gate of at least one fourth transistor to turn the at least one fourth transistor on, with the alternating current flowing between a first connection node and a second connection node of the at least one fourth transistor; and
transmitting the alternating current from the first terminal of the rectifier to the output conductive line via at least one third component;
wherein the first component, the second component, the first transistor and the second transistor form a first rectifier and wherein each third component, each fourth component, each third transistor, and each fourth transistor form a second rectifier among the at least two rectifiers.

10. The method according to claim 9, further comprising:
when the alternating current is in a negative phase:
controlling by the first voltage comparator the first voltage on the gate of the first transistor to turn the first transistor on with the alternating current flowing between the first connection node and the second connection node of the first transistor;
controlling by the second voltage comparator the second voltage on the gate of the second transistor to turn the second transistor off;
transmitting the alternating current from the second terminal of the rectifier to the output conductive line via a second component;
controlling by the first voltage comparator the first voltage on the gate of the at least one third transistor to turn the at least one third transistor on with the alternating current flowing between the first connection node and the second connection node of the at least one third transistor;
controlling by the second voltage comparator the second voltage on the gate of the at least one fourth transistor to turn the at least one fourth transistor off; and
transmitting the alternating current from the second terminal of the rectifier to the output conductor line via at least one fourth component;
wherein the first component, the second component, the first transistor and the second transistor form a first rectifier and wherein each third component, each fourth component, each third transistor, and each fourth transistor form a second rectifier among the at least two rectifiers.

11. The method according to claim 10, further comprising:
controlling at least one switch to enable or prevent the operation of the third and fourth components;
generating a direct current at an output of the rectifier;
detecting an intensity of the direct current; and
controlling the at least one switch to enable the operation of the third and fourth components when the direct current exceeds a threshold current.

12. The method according to claim 9, wherein the first voltage and the second voltage are generated so that the first transistor, the second transistor, the third transistor, and the fourth transistor are enabled when the alternating current is greater than a threshold current.

13. A rectifier circuit, comprising:
a first pair of cross-coupled transistors connected between first and second rectifier inputs and a rectifier output;
a first transistor having a conduction path between the first rectifier input and a reference node;
a first voltage comparator configured to compare a voltage at the first rectifier input with a voltage at the reference node and control the first transistor in response to the comparison;
a second transistor having a conduction path between the second rectifier input and the reference node;
a second voltage comparator configured to compare a voltage at the second rectifier input with the voltage at the reference node and control the second transistor in response to the comparison;
a second pair of cross-coupled transistors connected between the first and second rectifier inputs and the rectifier output, said second pair including at least one switch configured to selectively connect terminals of the second pair in response to a control signal; and
a detection circuit configured to detect an intensity of a direct current at the rectifier output and to generate the control signal for the at least one switch based on the detected intensity of the direct current.

14. The rectifier circuit according to claim 13, further comprising:
a first diode coupled between the first rectifier input and the reference node; and
a second diode coupled the second rectifier input and the reference node.

15. The rectifier circuit of claim 13, further comprising:
a third transistor having a conduction path between the first rectifier input and the reference node;
a first logic circuit configured to logically combine an enable signal and an output of the first voltage comparator to control the third transistor;
a fourth transistor having a conduction path between the second rectifier input and the reference node; and
a second logic circuit configured to logically combine the enable signal and an output of the second voltage comparator to control the fourth transistor.

16. A rectifier circuit, comprising:
a first pair of cross-coupled transistors connected between first and second rectifier inputs and a reference node;
a first transistor having a conduction path between the first rectifier input and a rectifier output;
a first voltage comparator configured to compare a voltage at the first rectifier input with a voltage at the rectifier output and control the first transistor in response to the comparison;
a second transistor having a conduction path between the second rectifier input and the rectifier output;
a second voltage comparator configured to compare a voltage at the second rectifier input with the voltage at the rectifier output and control the second transistor in response to the comparison;
a second pair of cross-coupled transistors connected between the first and second rectifier inputs and the reference node, said second pair including at least one switch configured to selectively connect terminals of the second pair in response to a control signal; and
a detection circuit configured to detect an intensity of a direct current at the rectifier output and to generate the control signal for the at least one switch based on the detected intensity of the direct current.

17. The rectifier circuit according to claim 16, further comprising:
a first diode coupled between the first rectifier input and the rectifier output; and
a second diode coupled the second rectifier input and the rectifier output.

18. The rectifier circuit of claim 16, further comprising:
a third transistor having a conduction path between the first rectifier input and the rectifier output;
a first logic circuit configured to logically combine an enable signal and an output of the first voltage comparator to control the third transistor;
a fourth transistor having a conduction path between the second rectifier input and the rectifier output; and
a second logic circuit configured to logically combine the enable signal and an output of the second voltage comparator to control the fourth transistor.

19. A rectifier circuit, comprising:
a first transistor having a conduction path between the first rectifier input and a reference node;
a first voltage comparator configured to compare a voltage at the first rectifier input with a voltage at the reference node and control the first transistor in response to the comparison;
a second transistor having a conduction path between the second rectifier input and the reference node;
a second voltage comparator configured to compare a voltage at the second rectifier input with the voltage at the reference node and control the second transistor in response to the comparison;
a third transistor having a conduction path between the first rectifier input and a rectifier output;
a third voltage comparator configured to compare the voltage at the first rectifier input with a voltage at the rectifier output and control the third transistor in response to the comparison;
a fourth transistor having a conduction path between the second rectifier input and the rectifier output;
a fourth voltage comparator configured to compare the voltage at the second rectifier input with the voltage at the rectifier output and control the fourth transistor in response to the comparison;
a fifth transistor having a conduction path between the first rectifier input and the reference node;
a first logic circuit configured to logically combine an enable signal and an output of the first voltage comparator to control the fifth transistor;
a sixth transistor having a conduction path between the second rectifier input and the reference node; and
a second logic circuit configured to logically combine the enable signal and an output of the second voltage comparator to control the sixth transistor.

20. The rectifier circuit of claim 19, further comprising:
a seventh transistor having a conduction path between the first rectifier input and the rectifier output, wherein the seventh transistor is controlled by an output of the third voltage comparator; and
an eighth transistor having a conduction path between the second rectifier input and the rectifier output, wherein the eighth transistor is controlled by an output of the fourth voltage comparator.
